(19) United States
(12) Patent Application Publication
(10) Pub. No.: US 2024/0160703 A1
(43) Pub. Date: May 16, 2024

(54) SECURE DIGITAL ASSET LEASING SYSTEM

(71) Applicant: Numéraire Financial, Inc., Chicago, IL (US)

(72) Inventors: Alexander Lipton, Abu Dhabi (AE); Marsha P. Lipton, Abu Dhabi (AE); Thomas P. Hardjono, Winchester, MA (US)

(21) Appl. No.: 18/387,414

(22) Filed: Nov. 6, 2023

Related U.S. Application Data
(60) Provisional application No. 63/383,628, filed on Nov. 14, 2022.

(51) Int. Cl. G06F 21/10

(52) U.S. Cl. CPC G06F 21/1087; G06F 2221/2103; G06F 2221/2137

(57) ABSTRACT

Techniques are described for providing a secure digital asset leasing system that enables digital assets to be leased or loaned from owners' computing devices to lessees' computing devices. For example, once a digital asset is leased to a lessee using the secure digital asset leasing system, the original owner of the digital asset may cease to have access to the digital asset until the end of the lease period. The leasing or loaning of a digital asset can broadly refer to a process in which a lessee obtains authorization to use or “consume” the digital asset (e.g., to display the digital asset on a digital display device) obtained from the owner for a defined duration. During the lease period, a trusted computing device associated with the lessee periodically synchronizes to a synchronization authentication service. A digital asset is accessed or consumed by a lessee using an approved trusted computing device that is securely connected to a display unit.

### CROSS-REFERENCE TO RELATED APPLICATION

This application claims priority to U.S. Patent Application Ser. No. 63/383,628, filed on Nov. 14, 2022, the entire contents of which are hereby incorporated by reference as if fully set forth.

### BACKGROUND

There is a growing interest in the creation and use of digital assets including digital images, videos, audio, and the like.

### BRIEF DESCRIPTION OF DRAWINGS

Various examples in accordance with the present disclosure will be described with reference to the drawings, in which:

FIG. 1 is a diagram illustrating an example computer-implemented digital asset leasing system according to some examples.

FIG. 2 is a diagram illustrating example decentralized ledger technology (DLT) systems used by a digital asset leasing system according to some examples.

FIG. 3 is a diagram illustrating the use of an asset leasing protocol by a digital asset leasing system according to some examples.

FIG. 4 is a diagram illustrating the use of a liveliness protocol by a synchronization authentication service to ensure continual liveliness verification of a trusted device (e.g., owned by a lessee) that is currently consuming (e.g., displaying) a digital asset according to some examples.

FIG. 5 is a diagram illustrating the display of a synchronization counter value in an authenticator display portion of a digital asset display unit and via a verifier app running on a separate computing device (e.g., a mobile device) according to some examples.

FIG. 6 is a diagram a computer-implemented system in which a subleasing arrangement of a digital asset from a primary lessee to a sub-lessee is performed according to some examples.

FIG. 7 is a diagram illustrating a computer-implemented system in which an insurance provider system performs verification of each of an owner's and lessee's trusted devices according to some examples.

FIG. 8 is a flow diagram illustrating operations for providing a secure digital asset leasing system that enables the lease (or loan) of digital assets from an owner to a lessee according to some examples.

FIG. 9 is a block diagram illustrating an example computer system that may be used in some examples.

### DETAILED DESCRIPTION

The present disclosure relates to methods, apparatus, systems, and non-transitory computer-readable storage media for providing a secure digital asset leasing system that enables digital assets to be “leased” (or loaned) from owners' computing devices to lessees' computing devices. According to some examples described herein, once a digital asset is leased to a lessee using the secure digital asset leasing system, the original owner of the digital asset may cease to have access to the digital asset until the end of the lease period. As used herein, the leasing or loaning of a digital asset broadly refers to a process in which a lessee obtains authorization to use or “consume” the digital asset (e.g., to display the digital asset on a digital display device) obtained from the owner for a defined duration of time. During the duration of a defined lease time period, in some examples, a trusted computing device associated with the lessee periodically synchronizes to a synchronization authentication service selected by the owner. The synchronization authentication service provides continual authentication and liveliness proof regarding the state of the digital asset during its possession by a lessee's computing device. In some examples, a digital asset can only be accessed or consumed by a lessee using an approved trusted computing device that is securely connected to a display unit that permits the asset to be viewed by the lessee.

In some examples, a mobile app (or other type of software application) is provided that enables a lessee (or any other viewer of a trusted display unit) to validate the authenticity of a loaned digital asset and the freshness of the displayed digital asset. The mobile app, for example, reads a random synchronization counter value (associated with the digital asset) from a blockchain and displays the counter value for comparison with a counter value displayed by the trusted computing device in association with the display of the digital asset. The synchronization authentication service re-computes the counter value on a periodic basis (e.g., every few minutes or other period) and transmits a new synchronization counter value to the trusted device and to the blockchain. This process, for example, can help prevent the synchronization counter value from being forged by attackers.

In some examples, an insurance provider seeking to provide insurance of an asset to be leased between the owner and lessee utilizes a device status verification service to ensure that both trusted devices (associated with each of the owner and at the lessee) complies with an insurance policy defined by the insurance provider.

There is a growing interest in the creation and distribution of digital artwork and other types of digital assets that are restricted in number and in circulation. Creators and owners of digital assets may desire to trade these assets globally, while at the same time requiring counterfeit detection and prevention mechanism to be employed. In many instances, the owners of high-value physical assets (e.g., rare artwork) are prevented from utilizing or enjoying the asset because of the extreme value of the asset. In these and other scenarios, a digital scan of the asset can be created. For example, the original physical asset might be a painting and a digital asset corresponding to the painting can be a high-resolution scan of the painting. For some types of digital assets, such as limited-edition digital artwork, the creator or owner of the digital artwork desires for the digital asset to be consumed (e.g., viewed on an electronic visual display) in such a way that the artwork file cannot be copied.

Similar to items of physical artwork (e.g., paintings or sculptures), the legal owner of a digital artwork may wish to loan the digital artwork to a colleague or to a museum. In the case of physical artworks, the constraints imposed by the physical characteristics of the artwork (e.g., the size of painting or weight of a sculpture) may limit or prevent the artwork from being moved around frequently. Thus, the loaning of a physical artwork may typically occur over extended periods of time (e.g., 6 months or longer). In the case of digital artworks, these physical constraints are obviated in the sense that sending the digital artwork file from one entity to another in different geographic locations can occur in a matter of seconds. However, the digital nature of the artwork introduces new challenges beyond counterfeit prevention. These challenges include, for example, observing limited-edition digital artworks according to constraints legally imposed by the creator/owner of the digital artwork.

As an example, consider an owner of a digital artwork (e.g., a digital file representing and capable of being displayed as a physical or digital item of visual artwork), where the owner desires to loan the digital artwork to two (2) art museums each located in a different part of the world (and each possibly in a different time zone). For example, the owner of the digital artwork may wish to loan the digital artwork to both an art museum in New York and an art museum in Abu Dhabi. As part of this effort, the owner defines the following loan policy:
The digital artwork can be displayed in the New York Museum only during the times of 10:00 AM to 3:00 PM U.S. Eastern Standard Time (EST), and the digital artwork can be displayed in the Abu Dhabi Museum from 12:00 PM to 5:00 PM Gulf Standard Time (GST).

In this example, it is desirable for a digital asset leasing system to ensure that the policy of loaning or leasing the digital artwork is enforced concurrently at the New York Museum and in the Abu Dhabi Museum. Furthermore, it may be desirable for the digital asset leasing system to ensure that the artwork is on display to the public in only one of these museums at any given time. That is, it may be desirable for a digital asset leasing system to ensure that, if the digital artwork is displayed in one location, it cannot be displayed in other geographic locations—including at the original owner's location.

Digital Asset Leasing System Overview

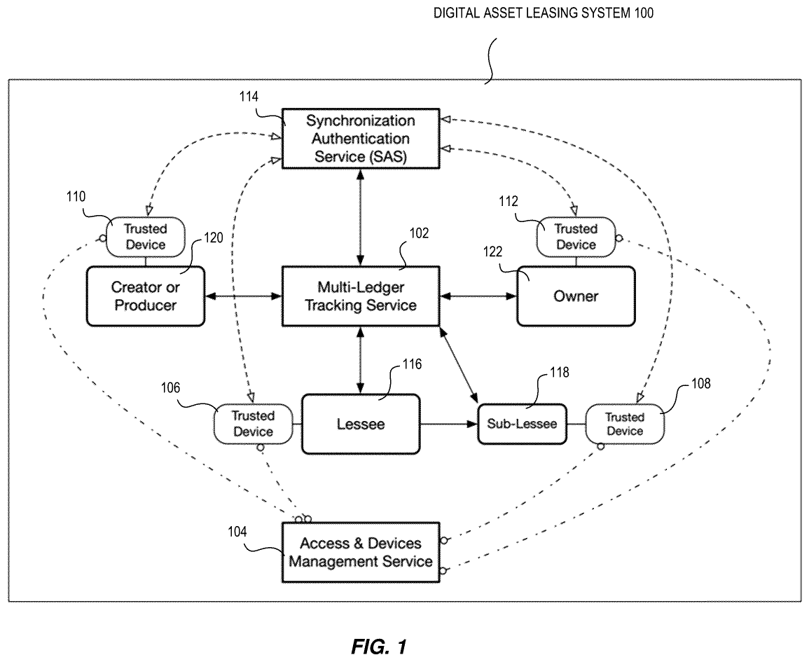

FIG. 1 illustrates a computer-implemented system for providing a digital asset leasing system according to some examples. According to examples described herein, a digital asset leasing system 100 includes some or all of the following services and components:
Multi-ledger tracking service 102: In some examples, a multi-ledger tracking service 102 uses one or more distributed ledger technology (DLT) systems (or ledgers) in parallel and in an interconnected manner to track digital asset leasing events in an irrefutable manner. Each of the digital ledgers used as part of the multi-ledger tracking service 102 can be implemented as a private, permissioned ledger deployed using servers in one or more private data centers (e.g., managed by an entity responsible for the digital asset leasing system), on servers provided by a cloud provider network (e.g., as part of a ledger database service, blockchain service, or the like), or combinations thereof.
Access & devices management service 104 (or “ADMS”): In some examples, an access and devices management service 104 ensures that each trusted device (e.g., a trusted device 106 associated with a lessee 116, trusted device 108 associated with a sub-lessee 118, trusted device 110 associated with a creator or producer 120, trusted device 112 associated with an owner 122, etc.) that obtains or consumes a given digital asset is configured correctly (including, e.g., the hardware, firmware, and software of the trusted device), possesses the correct keys arrangement, and that it can provide an attestation to its current operation state. For example, the access and devices management service 104 can use device attestation mechanisms to ensure that the software (e.g., including a client application used to interface with various components of the digital asset leasing system 100), hardware, and data stored by the device is as expected by the system. In concert with the asset synchronization authentication service 114 (or “SAS”), the access and devices management service 104 ensures that the digital asset leasing system 100 can prove that policies related to the asset have been observed. In some examples, the access and devices management service 104 is implemented as a software-based service or application running on servers deployed in a private data center or provided by a cloud provider network.
Synchronization authentication service 114 (or “SAS”): According to examples described herein, a synchronization authentication service 114 performs a continual periodic synchronization via a liveliness protocol with the trusted device as the endpoint. Among other benefits, the liveliness protocol ensures that an asset is consumed in a designated trusted device at any one time. In some examples, the synchronization authentication service 114 is implemented as a software-based service or application running on servers deployed in a private data center or provided by a cloud provider network, where the service/application may be part of or distinct from the access and devices management service 104.

The Multi-Ledger Tracking Service

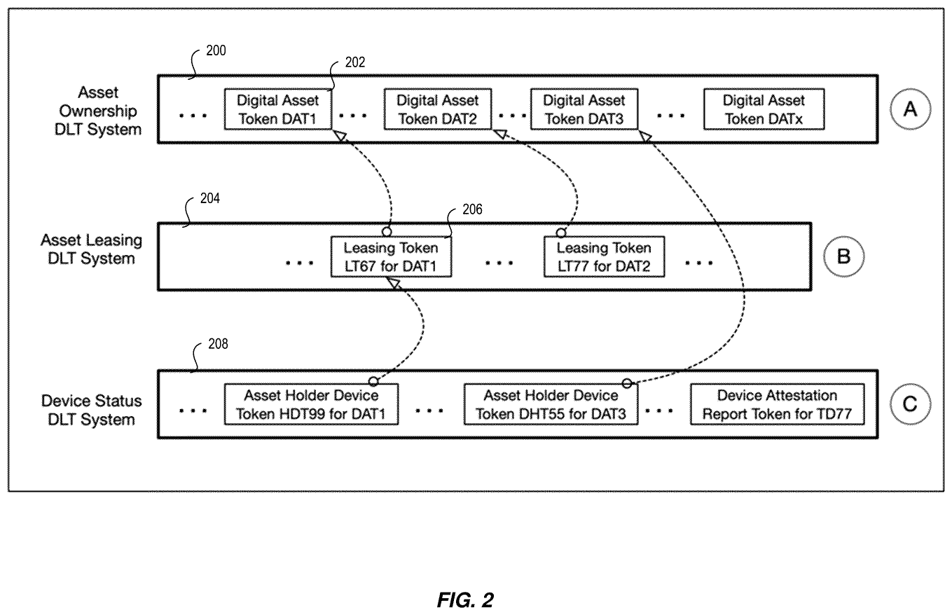

In some examples, a multi-ledger tracking service 102 maintains one or more types of ledgers and tokens associated with the different entities and asset states. The multi-ledger tracking service 102 can be implemented using one or more distinct decentralized ledger technology (DLT) systems, with each DLT system to be used to track different types of tokens. In other examples, the system can use a single DLT system and different types of tokens to track entities, digital assets, and leasing events. In other examples, the tracking of entities and asset states can be implemented using one or more centralized ledger systems. As used herein, the term “ledger” refers broadly to any type of DLT system. FIG. 2 is a diagram illustrating example DLT systems used by a digital asset leasing system according to some examples.

Asset Ownership DLT System

In some examples, an asset ownership DLT system 200 is used to facilitate the exchange of digital asset tokens (or “DATs”) (e.g., a digital asset token 202), where a digital asset token serves as a representation of a digital asset. As indicated above, the asset ownership DLT system 200 can be implemented as a permissioned ledger deployed on servers located in one or more data centers, cloud provider networks, or combinations thereof. In the context of the digital asset leasing system 100, the ownership of a digital asset token is used to evidence the ownership of the corresponding digital asset represented by that token.

In some examples, an owner of a digital asset can register the digital asset with the digital asset leasing system 100 to enable the digital asset to be leased to other entities. The digital asset leasing system 100, for example, can include a web-based service or other type of software-based application, databases, ledgers, and other components that enable users to create accounts, to register digital assets, to request the lease of a digital asset owned by a user to a different user, and the like. For example, a web-based service provided by the digital asset leasing system 100 can include application programming interfaces (APIs), web-based frontends, and the like. In other examples, the digital asset leasing system 100 can include client/server applications, mobile apps, or other types of software applications that enable users to perform the actions described herein. A user creating an account with the digital asset leasing system 100 can provide information identifying the user (e.g., the user's name, location, one or more addresses (public key, Uniform Resource Locator (URL), etc.), and the like), securely provide a copy of a digital asset (e.g., as a file), provide leasing policy configurations, etc.

In some examples, a digital asset token stored on an asset ownership DLT system 200 (e.g., as a result of a user using a computing device to interact with the digital asset leasing system 100 and to register a digital asset, or responsive to users using an application to exchange ownership of a digital asset) is signed by the previous owner (the originator address) and addressed to the new/current owner (the beneficiary address). A digital asset token can include some or all of the following information:
The originator address (e.g., a public key) of the previous owner of the digital asset.
The beneficiary address (e.g., a public key) of the new/current owner of the digital asset.
A cryptographic hash of the digital asset file.
The identity of the creator/producer of the digital asset.
The timestamp of the creation of the token.

Asset Leasing DLT System

In some examples, an asset leasing DLT system 204 is used by owners of digital asset tokens (and therefore of the corresponding digital asset) to lease a digital asset to a lessee (or “borrower”) person or entity. The lease of an asset from an owner to a lessee can be established in this DLT system using a leasing token (e.g., a leasing token 206). In some examples, an asset leasing DLT system 204 also carries a proof-of-insurance token for the case when the asset is leased from the owner to a lessee. A proof-of-insurance token is issued by an insurance provider based on the asset in question.

A leasing token can include some or all of the following information:
The owner address (e.g., a public key) of the current owner of the digital asset. This address is identical to the current (latest) owner address in the corresponding digital asset token.
The lessee address (e.g., a public key) of the lessee of the digital asset (e.g., where the lessee address can be provided by a user that has registered with the digital asset leasing system, provided identifying information such as a blockchain address (e.g., a public key), provided one or more device identity keypairs associated with one or more of the user's trusted devices, etc.).
The cryptographic hash of the digital asset file.
One (or more) cryptographic hashes of the public half of a device identity key pair (DIK-Public) of the trusted device to be used by the lessee. There may be multiple trusted devices, in which case multiple hash values can be listed. As indicated above, a device identity key pair can be provided during a registration process with the digital asset leasing system 100 initiated by a user associated with the one or more trusted devices.
The cryptographic hash of the digital asset token (on the asset ownership DLT system 200) corresponding to the digital asset.
The cryptographic hash of the proof-of-insurance token. Additional details related to a proof-of-insurance token are provided below.
One or more lease policies defined by the owner.
The timestamp of the creation of the leasing token.
A digital signature of the owner.

A proof-of-insurance token (or “PIT”) includes some or all of the following information:
The legal identity of the insurance provider.
An address (e.g., a public key) of the insurance provider providing insurance to the owner and/or lessee of the digital asset.
The owner address (e.g., a public key) of the current owner of the digital asset.
The cryptographic hash of the public half of device identity key pair (DIK-Public) of the trusted device that currently possesses the digital asset (e.g., the owner's trusted device).
The lessee address (e.g., a public key) of the lessee of the digital asset.
The cryptographic hash of the public half of device identity key pair (DIK-Public) of the trusted device to be used by the lessee to possess the digital asset.
The cryptographic hash of the digital asset file.
The cryptographic hash of the digital asset token (on the asset ownership DLT system 200) corresponding to the digital asset.
A legal description of the terms of the insurance.
The timestamp of the creation of this proof-of-insurance token.
Digital signature of the insurance provider.

Device Status DLT System

In some examples, a device status DLT system 208 is used by subsystems of the digital asset leasing system 100 to track the status of trusted devices and their access to digital assets. In some examples, there are at least two types of tokens stored on the device status DLT system 208: an asset holder device token (or “AHD” token), and a device attestation report token (or “DAR” token).

In some examples, a device attestation report token is used by a trusted device to record (on the device status DLT system 208) device attestations performed by the trusted device (e.g., as part of a trusted device obtaining access to a digital asset in the context of a lease). A device attestation report token is created by the lessee's trusted device 300 and is addressed to the access and devices management service 104 (e.g., using a public key of the service 104).

In some examples, an asset holder device token is used by the access and devices management service 104 to record the fact that a digital asset instance is currently assigned to a trusted device (e.g., belonging to a lessee). This identification is by way of the public half of the device identity key pair (DIK-Public) of the trusted device. In some examples, an asset holder device token is created by the access and devices management service 104 and is addressed to the lessee.

In some examples, a device attestation report (or “DAR”) token includes some or all of the following information:
The originator address (e.g., a public key) of the lessee of who owns/controls the associated trusted device.
The beneficiary address (e.g., a public key) of the access and devices management service 104.
The public half of the device identity key pair (DIK-Public) of the trusted device.
The hash of the last/previous device attestation report token (that was last recorded by the trusted device) on the device status DLT system 208.
The hash of the signed device attestation report (or “DAR”) file computed by the trusted device. The device attestation report file is signed using the private half of the device identity key pair (DIK-Private).
The timestamp of the creation of this token.
Digital signature of the lessee.

In some examples, an asset holder device token (or “AHD” token) includes some or all of the following information:
The originator address (e.g., public key) of the access and devices management service 104.
The beneficiary address (e.g., public key) of the lessee of the digital asset.
The public half of the device identity key pair (DIK-Public) of the lessee's trusted device.
A pointer to (e.g., a hash of) the last device attestation report token recorded by the trusted device on the device status DLT system 208.
A cryptographic hash of the leasing token (on the asset leasing DLT system 204) evidencing the lease from the owner to the lessee.
The cryptographic hash of the digital asset file belonging to the owner.
The timestamp of the creation of this token.
Digital signature of the ADMS system.

In some examples, a synchronization order token (or “SOT”) includes some or all of the following information:
The originator address (e.g., a public key) of the synchronization authentication service 114.
The beneficiary address (e.g., a public key) of the lessee of the digital asset.
The public half of the device identity key (DIK-Public) of the lessee's trusted device.
A pointer to (e.g., a hash of) the last synchronization order token recorded by the synchronization authentication service 114 on the device status DLT system 208.
The synchronization counter value (or “SCV”) for the current duration for the time period P.
The current timestamp (according to a clock managed by the synchronization authentication service 114).
The start time of the validity of the synchronization counter value.
The end time of the validity of the synchronization counter value.
Digital signature of the synchronization authentication service 114.

In some examples, a synchronization response token (or “SRT”) includes some or all of the following information:
The originator address (e.g., a public key) of the trusted device (e.g., the device identity key (DIK-Public)).
The beneficiary address (e.g., a public key) of the synchronization authentication service 114.
The pointer to (e.g., a hash of) the last synchronization order token stored by the trusted device on the device status DLT system 208.
A current timestamp.
Digital signature of the synchronization authentication service 114.

Policies for the Lease of Digital Assets

According to examples described herein, a digital asset leasing system 100 implements a secure and verifiable mechanism for owners of a digital asset to lease the digital asset to a lessee in such a way that it enforces (i) the creator's policies for copyright as well as rules pertaining to the digital asset consumption by the owner and (ii) the general policies pertaining to leasing of asset in the possession of the owner.

The following are examples of processes and policies implemented and enforced by a digital asset leasing system 100:
Assignment of a new leasing token from the owner to the lessee: The process for leasing a digital asset comprises the current owner creating a new leasing token on the asset leasing DLT system 204 that is addressed to the address (e.g., a public key) of the lessee. As indicated, the owner of a digital asset can create a new leasing token on the asset leasing DLT system 204 using a web-based frontend, API, or other interface of the digital asset leasing system 100 that receives as input an identifier of the digital asset, an identifier of the lessee, and any other settings associated with the lease (e.g., as discussed below, a duration of the lease, early termination conditions, etc.).
Time duration of lease: The owner determines the duration of time of the lease and that duration is included as a parameter in the leasing token (LT) via the owner providing the duration as input to the digital asset leasing system 100.
Lease early termination: In some examples, the owner can provide input to the digital asset leasing system 100 indicating conditions upon which the owner can cancel (or abort) the lease of a digital asset. The digital asset leasing system 100 can cause these conditions upon which the lease can be broken (terminated early) to be specified in the leasing token created to evidence the lease of the digital asset.
Owner prevented from consuming the asset while it is leased: In some circumstances, when a digital asset is leased from an owner to a lessee, the digital asset leasing system 100 prevents the owner from consuming the digital asset on one or more of the owner's trusted devices. This is analogous, for example, to the situation with many types of real-world physical assets (e.g., an owner typically cannot use real estate when it is being leased out).
Subleasing: The owner of the digital asset may permit/deny the subleasing of the digital asset to other entities. In this case, the subleasing terms are stated in the leasing token. Here, subleasing refers to the ability for a lessee to further grant a new leasing token to another entity on the asset leasing DLT system 204.
Lessee utilizing multiple trusted devices: In the case that a lessee employs multiple trusted devices, the leasing token includes a hash of each of the device identity keys (see below) of these trusted devices. In the case of multiple trusted devices, only one or more specified trusted device may be permitted to obtain access to the digital asset at any one time during the duration of the lease depending on the lease conditions specified by the owner.

Asset Leasing Protocol (ALP)

According to some examples, an asset leasing protocol (or “ALP”) used by the digital asset leasing system 100 is driven by (or initiated by) an owner of a digital asset by creating a leasing token (or “LT”) on the asset leasing DLT system 100 addressed to the lessee. The signed leasing token represents the evidence of the lease of the asset from the owner to the lessee. The leasing token further signals to the other part of the system that a leasing event has occurred and that the new lessee is to be provided access to the digital asset via the lessee's trusted device.

As mentioned previously, the access and devices management system 104 (ADMS) ensures that each trusted device that handles a given digital asset is in the correct technical configuration (e.g., hardware, firmware, software, using device attestation mechanisms), correct keys arrangement, and that it can provide an attestation to its current operation state. In concert with the asset synchronization authentication service 114 (SAS), the asset leasing protocol and the trusted devices ensure that the digital asset leasing system 100 can prove that the digital asset is authentic and that liveliness is maintained.

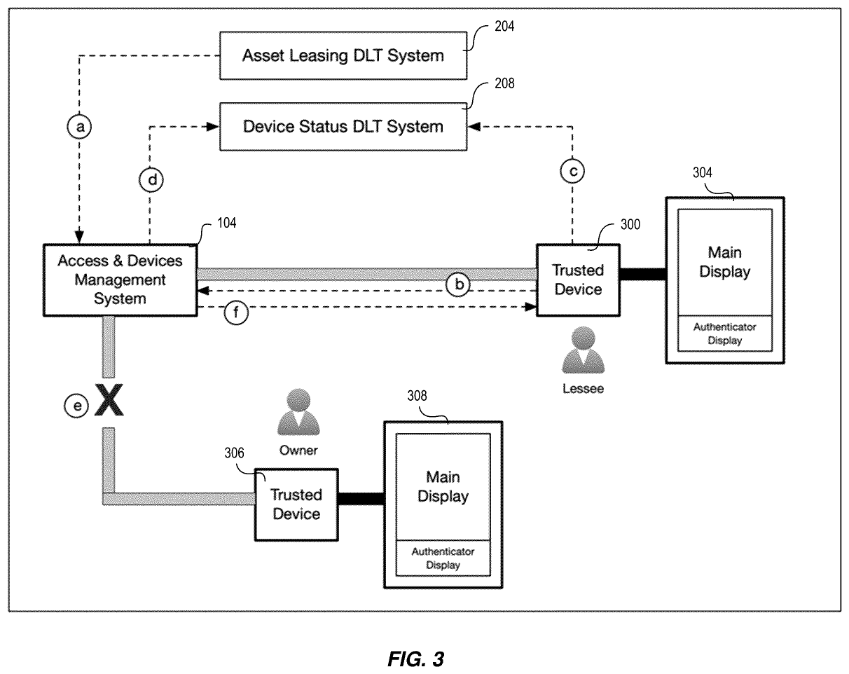

FIG. 3 is a diagram illustrating the use of an asset leasing protocol used by a digital asset leasing system according to some examples.

Owner creates a new leasing token: The owner of a digital asset leases out a digital asset to a lessee by creating a new leasing token (addressed to the lessee) on the asset leasing DLT system 204 and, at the circle labeled “a” in FIG. 3, the access and devices management system 104 monitors the DLT system and identifies the new leasing token. As indicated above, the owner of a digital asset can create the leasing token using an application, web-based interface, or other interface provided by the digital asset leasing system 100 to provide input identifying the digital asset, identifying the lessee (e.g., as registered by the digital asset leasing system 100), and any associated lease configurations.

The access and devices management system prepares a new asset holder device token: In some examples, a component of the access and devices management system 104 continually monitors the asset leasing DLT system 204 and, upon identification of a new leasing token, creates and stores a corresponding asset holder device token (on the device status DLT system 208) that carries the relevant information about the digital asset and the lessee. As indicated, the access and devices management system 104 can create the asset holder device token using an API or other interface provided by a system managing the device status DLT system 208.

Access and devices management system requests attestation of lessee's trusted device: In some examples, the access and devices management service 104 then establishes a secure connection to the trusted device 300 (connected to a digital display 304) belonging to the lessee (e.g., using a network identifier of the trusted device 300 provided during registration with the digital asset leasing system 100 by the associated lessee). The access and devices management service 104 requests the trusted device 300 to generate a signed device attestation report regarding the components of the trusted device 300 and to deliver the device attestation report to the access and devices management service 104.

Delivery of device attestation report and recording of device attestation report token: In some examples, at circle “b” in FIG. 3, the lessee's trusted device 300 generates and sends the device attestations report via the secure channel to the access and devices management service 104 and, at circle “c”, the trusted device 300 stores a device attestations report token on the device status DLT system 208.

Access and devices management system appraisal of device attestations report: In some examples, the access and devices management service 104 performs an appraisal of the device attestations report (e.g., by comparing values contained in the attestation report to values specifying expected or minimum device configurations) and determines whether to grant the trusted device 300 access to the digital asset. In the case where the trusted device 300 does not meet the system compliance requirements of the owner, in some examples, the access and devices management service 104 further requests the trusted device 300 to perform software and firmware updates.

Access and devices management service validation of device attestations report token: In some examples, the access and devices management service 104 identifies the device attestations report token recorded by the trusted device 300 on the device status DLT system 208. The access and devices management service 104 verifies that the device attestations report token includes the same hash of the signed device attestation report file as that sent by the trusted device 300 to the access and devices management service 104. This ensures that the trusted device is not lying to the access and devices management service 104 (e.g., that it is presenting a different device attestations report to the access and devices management service 104 than to the device status DLT system 208, e.g., by checking a history of the device attestations report tokens recorded by the trusted device 300).

The access and devices management service 104 stores the new asset holder device token: The access and devices management service 104 then, at circle “d”, records a new asset holder device token (corresponding to the lessee's trusted device 300) on the device status DLT system 208.

Termination of connection to the owner's trusted device 300 & memory erasure: In some examples, assuming the leasing conditions associated with the digital asset restrict consumption of the digital asset to only one or more devices at any given time, the access and devices management service 104 instructs the trusted device 306 (to which it is currently connected and synchronized) to erase the protected memory in the trusted device 302 containing the digital asset. For example, at circle “e,” the access and devices management service 104 can optionally terminate its secure connection with the owner's trusted device 306, thereby prohibiting the owner from consuming or utilizing the digital asset during the time duration of the lease.

Delivery of protected asset to lessee's trusted device: The access and devices management service 104 and the trusted device 300 establish a mutually authenticated secure channel (or use a previously established secure channel) using a security protocol such as, e.g., the Transport Layer Security (TLS) protocol. In some examples, at circle “f,” the access and devices management system 104 sends a copy of the digital asset to the trusted device 300 using the secure connection.

Liveliness Protocol

Once a digital asset has been leased by a first entity (e.g., an owner of the digital asset) to a second entity (e.g., a lessee, by sending causing the access and devices management service 104 to send a copy of the digital asset to a trusted device associated with the lessee), in some examples, a synchronization authentication service 114 periodically interacts with the lessee's trusted device using a liveliness protocol. The liveliness protocol, for example, can be used to ensure the continual liveliness verification of the lessee's trusted device that is currently consuming (e.g., displaying or otherwise using) a loaned digital asset. This ensures that a trusted device in possession of a digital asset is operating in a secure state and that the digital asset remains protected in the trusted device. The liveliness protocol uses a synchronization counter value (or “SCV”) for each fixed period P of a time duration (e.g., P could be 5 minutes or any other duration of time).

In some examples, the synchronization authentication service 114 continually monitors the device status DLT system 208 for the presence of a new asset holder device token (created by the access and devices management service 104). The presence of a new asset holder device token signifies that the trusted device 300 (belonging to the lessee) identified in the asset holder device token is currently the holder of the digital asset.

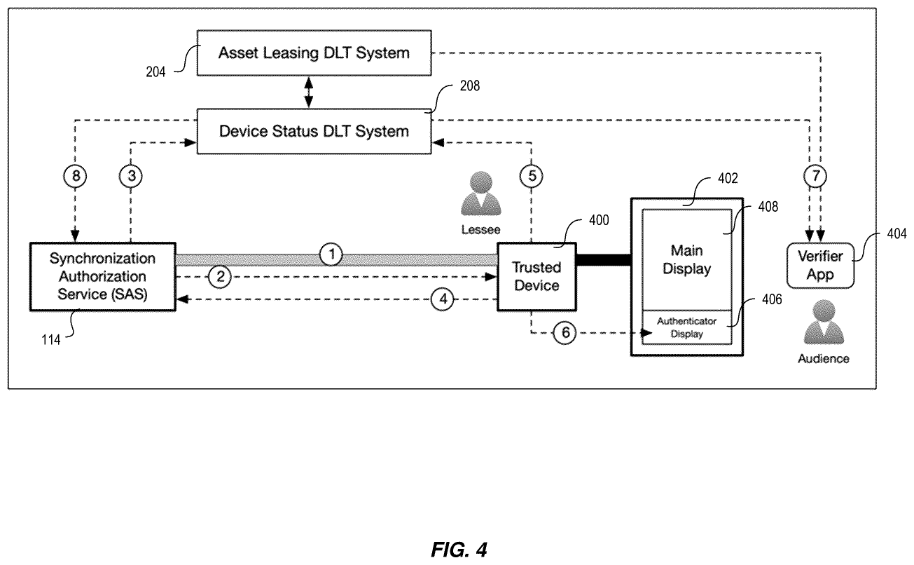

FIG. 4 is a diagram illustrating the use of a liveliness protocol by a synchronization authentication service to ensure continual liveliness verification of a trusted device (e.g., owned by a lessee) that is currently consuming (e.g., displaying) a digital asset according to some examples. The example of the liveliness protocol in FIG. 4 is shown for a given period P, where the protocol steps can be repeated for each period (e.g., when the synchronization authorization service 114 creates a new synchronization counter value).

Establishing a secure connection with the trusted device. Upon identifying a new digital asset holder device token on the device status DLT system 208, in some examples, the synchronization authorization service 114 establishes a secure connection to a trusted device 400 (connected to, e.g., a digital display 402) using the device's device identity key pair public key (included, e.g., in the corresponding asset holder device token).

In some examples, the synchronization authorization service 114 and the trusted device 400 establish a mutually authenticated secure channel using a standard protocol (such as TLS) to enable an ongoing connection between the synchronization authorization service 114 and the trusted device 400 (e.g., as shown by the circle labeled “1” in FIG. 4). Part of the TLS secure channel protocol is the establishment of a shared master session encryption key (or “SEK”), which is shared between the access and devices management service 104 and the trusted device 400.

Creation and delivery of device challenge: In some examples, at circle “2,” the synchronization authorization service 114 sends an encrypted device challenge (or “DC”) to the trusted device 400 using the secure connection. The device challenge number is encrypted using the device identity public key (DIK-PubKey) of the trusted device 400, forcing the device to decrypt the device challenge number to proceed with the protocol.

In some examples, the device challenge is generated by the synchronization authorization service 114 by incorporating several components including, e.g., the hash of the master session encryption key (SEK) used within the TLS secure connection between the synchronization authorization service 114 and the trusted device 400. This usage of the master session encryption key binds the device challenge to the TLS session and can be used, e.g., at a later time for auditing.

Publish synchronization token on the ledger: In some examples, the synchronization authorization service 114 then generates and stores a synchronization request token on the device status DLT system 208. The synchronization request token includes the synchronization counter value (SCV) for that duration for the time period P.

In some examples, a synchronization counter value (SCV) has three parts:
A hash of the device challenge sent to the trusted device 400.
A counter=Hash[Hash(device challenge)∥Hash(digital asset)∥Hash(current_time)]. As shown, the counter is a hash of the concatenation of three other hashed values.
The current time.

In some examples, at circle “3,” the synchronization authorization service 114 signs the synchronization token and stores the token on the device status DLT system 208.

Using the secure channel to the synchronization authorization service 114, at circle “4,” the trusted device 400 returns the plaintext device challenge value, which it successfully decrypted using its Device Identity Private Key (DIK-PrivKey). This, for example, can be used to prove to the synchronization authorization service 114 that the trusted device 400 is active and alive.

In some examples, at circle “5,” the trusted device 400 stores the device challenge number in a synchronization response token (or “SRT”) signed by the trusted device 400 onto the device status DLT system 204. The synchronization response token proves to the world that the trusted device 400 was able to access the device challenge number sent by the synchronization authorization service 114. In combination with the synchronization counter value (specifically the H(device challenge) value), it allows anyone to verify that synchronization authorization service 114 and the trusted device 400 conducted a live exchange of messages within the time period P.

In some examples, at circle “6,” the trusted device 400 visually displays the hash of the synchronization counter value (e.g., in humanly readable Hexadecimal or any other suitable format) in an authenticator display 406 (e.g., under the main display of the asset in the digital display 402).

In some examples, at circle “7,” a verifier app 404 (used by the lessee or asset audience) performs a verification of the SCV value. For example, the verifier app 404 can be a software-based application installable on mobile devices or other computing devices, where the app implements functionality used to obtain token information from a device status DLT system 208, asset leasing DLT system 204, and optionally other system components. In some examples, the verifier app 404 obtains the synchronization token from the device status DLT system 208 (which was published at circle “3” by the synchronization authorization service 114). Based on the obtained synchronization token, the verifier app 404 extracts the synchronization counter value and obtains the Hash(device challenge). The verifier app 404 also obtains the current time from the synchronization token.

In some examples, the verifier app 404 further obtains the asset ownership token from the asset leasing DLT system 204 and extracts the Hash(digital asset) value. The verifier app 404 then recomputes the synchronization counter value and compares this value against the synchronization counter value found in the synchronization token published at circle “3” by the synchronization authorization service 114. If the values match, the app determines that the trusted device 400 is fully synchronized with the synchronization authorization service 114 during time period P. If the values do not match, the app can indicate to the lessee or the audience that the digital asset is unauthenticated (e.g., to indicate that it could be counterfeit).

At the expiration of the leasing token, the synchronization authorization service 114 ceases to interact with the trusted device 400 of the lessee and ceases to synchronize with the trusted device 400. This means that, among others, the secure channel between the synchronization authorization service 114 and the trusted device 400 is terminated by the synchronization authorization service 114 and no new synchronization tokens are recorded by the synchronization authorization service 114 on the device status DLT system 208. This causes the verifier app 404, for example, to indicate (e.g., to the lessee or other audience of the asset) that the lease has ended.

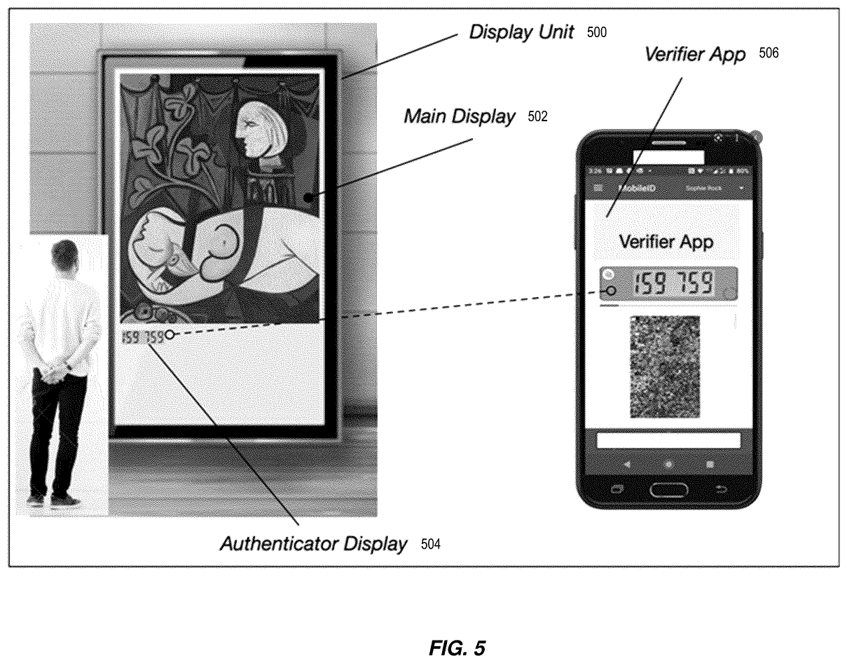

In some examples, a digital asset is consumed by displaying the digital asset on a digital display screen. This is particularly relevant, e.g., for visual artwork. In this case, a trusted device is securely connected to a display unit (e.g., the digital display 402), which comprises a main display part (e.g., a main display 408) and a separate authenticator display (e.g., an authenticator display 406). The main display 408 is used, e.g., to visually show the digital asset to viewers. The authenticator display 406, for example, is used to show evidence of the liveliness of the digital asset by way of showing visually to viewers a continually updated random synchronization counter value (SCV) that is transmitted by the synchronization authentication service 114. FIG. 5 is a diagram further illustrating the display of a synchronization counter value in an authenticator display portion of an asset display unit and in a verifier app running on a mobile device according to some examples. As shown, a display unit 500 includes a main display 502 (e.g., displaying visual artwork derived from a digital asset) and an authenticator display 500 (e.g., displaying a liveliness indicator, as described above). FIG. 5 further illustrates a verifier app 506, including display of a corresponding liveliness indicator that lessees or other audiences can use to verify the liveliness and authenticity of a displayed digital asset.

The synchronization counter value is also recorded by the synchronization authentication service 114 to the device status DLT system 208 as a means to prove the authenticity and liveliness of the digital asset being shown on the main display.

Any person (e.g., an audience) who views the digital asset (e.g., in a public museum) can use the verifier app 404 to obtain the synchronization counter value from the device status DLT system 208 and compare the digits to that shown on the authenticator display (e.g., authenticator display 406). If the two synchronization counter values are the same, the user can have confidence that the main display 408 is showing a legitimate digital asset. If the synchronization counter values are different, this signifies that either the digital asset is counterfeit or that the trusted device is not authorized to display the digital asset. The usage of the synchronization counter values is illustrated in FIG. 5. In the example of FIG. 5, the small authenticator display 500 (at the bottom of the main display 502) permits the user (e.g., visitor at the museum) to check that the digital art shown in the main display is genuine.

Sub-Leasing an Asset

Some art museums perform a loan exchange of artwork, whereby a piece of artwork is loaned to one museum (e.g., New York Museum) for a period of time before it is moved to a different museum (e.g., Abu Dhabi Museum). According to some examples, the described digital asset leasing system 100 supports the case for leases to be subleased to one or more sub-lessees. In this arrangement, the main lessee provides a list (to the asset owner) of other entities to act as a sub-lessee to the main lessee of the digital asset. Similar to lessees, a sub-lessee can register one or more trusted devices in their possession (e.g., by interacting with the digital asset leasing system 100) to be used to protect the digital asset while it is in the possession of the sub-lessee.

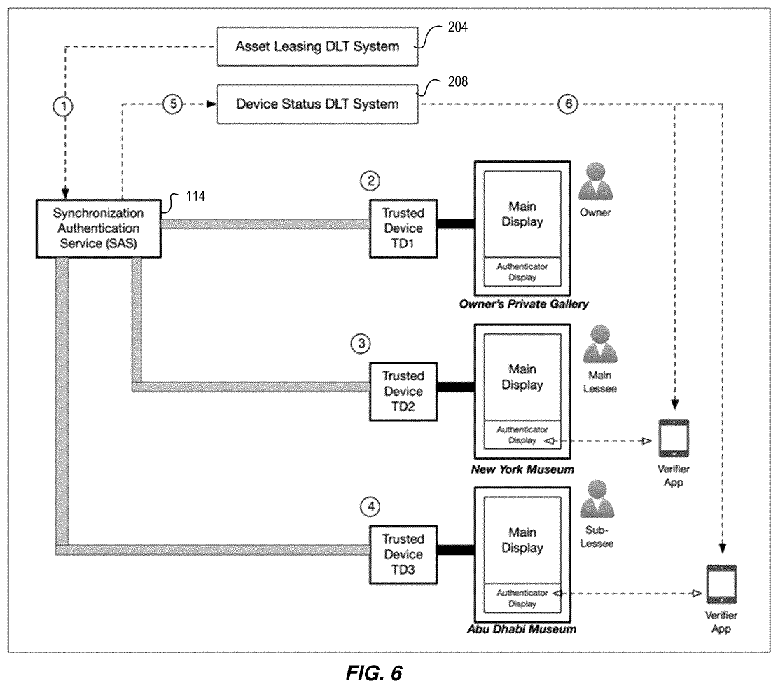

Similar to FIG. 4, in FIG. 6, an owner of a digital asset issues two (2) leasing tokens, where one token is addressed to the main lessee (e.g., New York Museum) while the other token is addressed to the sub-lessee (e.g., Abu Dhabi Museum).

Insurance of Digital Assets

Prior to being a lessee of a digital asset, an entity can obtain insurance from an insurance provider to cover for any potential harm to the asset. This may include insurance against delays in returning a leased asset due to unforeseen difficulties (e.g., technical difficulties with devices).

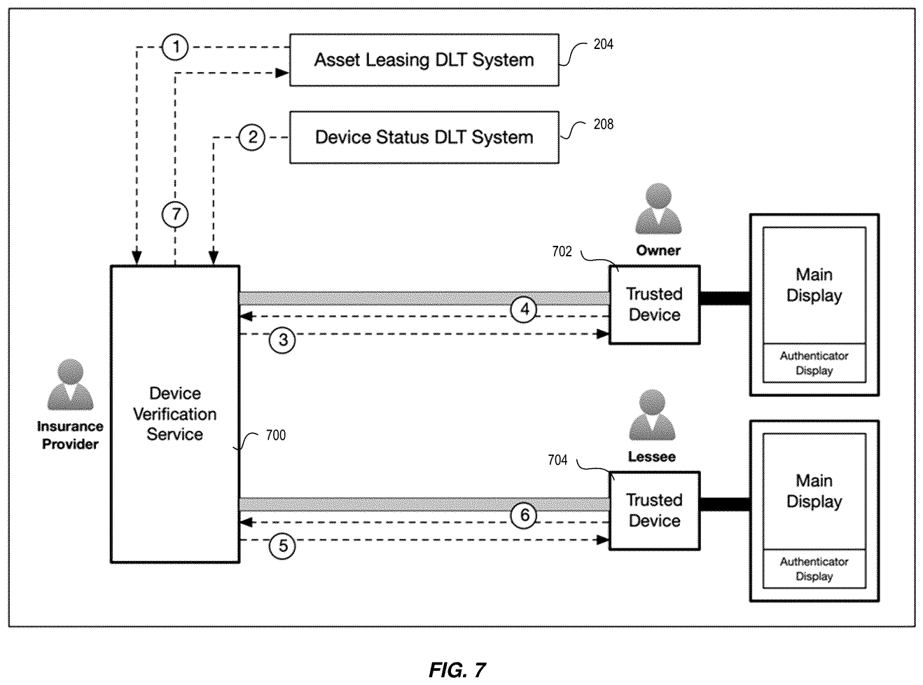

For an insurance provider, one major interest is in evaluating the trusted devices involved in the digital asset loans from a digital asset owner to a lessee. In some examples, an insurance provider thus verifies the quality and status of the trusted devices belonging to the asset owner and to the lessee, respectively. The insurance provider can use, for example, a device verification service (or “DVS”) to perform a live status verification with both of the trusted devices. An example device status verification protocol is illustrated in FIG. 7.

Verification of leasing token. In some examples, at circle “1,” a device verification service 700 associated with an insurance provider reads and verifies the leasing token issued by an owner to a lessee. This is to ensure, e.g., that the correct token exists and that the duration of the lease is still valid.

Verification of Device Attestation Report Tokens. In some examples, at circle “2,” the device verification service 700 reads and verifies the latest device attestation report token recorded by both the owner (by its trusted device) and the lessee (by its trusted device). Recall that a device attestation report token is used by a trusted device to record (on the device status DLT system 208) the latest device attestation which it performed (usually in the context of preparing the device to obtain access to the asset in the context of a lease).

Request Live Device Attestation Report from Owner's device. In some examples, at circle “3” and circle “4,” the device verification service 700 requests and obtains a new device attestation report from owner's trusted device 702. The device verification service 700 compares this attestation report from that which it found on the device status DLT system at circle “2”.

Request Live Device Attestation Report from Lessee's device. In some examples, at circle “5,” and circle “6,” the device verification service 700 request and obtains a new device attestation report from lessee's trusted device 704. The device verification service 700 compares this attestation report from that which it found on the device status DLT system at circle “2”.

Issue Proof of Insurance Token (PIT). In some examples, at circle “7,” the device verification service 700 is satisfied with the device attestation reports from the owner's trusted device 702 and the lessee's trusted device 704 and the device verification service 700 then issues a new proof of insurance token onto the asset leasing DLT system 204. This proof of insurance token functions as evidence that the insurance provider is providing financial insurance for the leasing of the asset for the duration of the lease specificized in the original leasing token that was issued by the owner to the lessee.

Note that for multiple lessees (e.g., sub-lessees), the same device status verification protocol is to be used by the device verification service 700 with all trusted devices involved. Although the use of insurance is described herein in the context of leased digital assets, the use of insurance can also be used for digital assets that are not leased (e.g., to insure the security of digital assets in the possession of one or more entities whether leased or otherwise).

### EXAMPLES

Example 1: A digital asset leasing system which utilizes several distributed ledger technology (DLT) systems (“ledgers”) in parallel in an interconnected manner, optionally together with the smart contract executable code that ensures that tasks related to an asset lease event are ordered in a correct sequence and in an irrefutable manner.

Example 2: A multi-ledger tracking service that issues a leasing token on a blockchain (addressed to a lessee) to signify the current state of the asset as being leased to a lessee. The leasing token is cryptographically bound to a digital asset token, which signifies the ownership of the asset by its current owner. A given leasing token is signed by the asset owner and issued to the lessee via a blockchain. Since the lessee may have more than one approved trusted device to access the asset and since there may be a policy that mandates access by one device at any one time, the lessee can provide a list of device identity keys (DIK-Public) of the trusted device of the lessee to the owner. The digital asset leasing system later stores an asset holder device token for each approved trusted device of the lessee. The asset holder device token identifies the lessee's specific trusted device that is currently in possession of the digital asset.

Example 3: A method to permit a sublease of a digital asset from a lessee to one or more sub-lessees using a loan delegation field within a leasing token. The loan delegation field carries the list of sub-lessee identities and the corresponding device identity keys of their trusted devices.

Example 4: An access and devices management service that controls access by a lessee (or sub-lessee) to a leased digital asset by controlling the cryptographic keys used to access the asset within the trusted device of the lessee or sub-lessee. The lessee (or sub-lessee), as the holder of the digital asset, can obtain access to the digital asset for the duration of the lease by way of its trusted device obtaining the relevant keys and the encrypted asset from the access and devices management service. The access and devices management service obtains access to the digital asset from its owner and encrypts the asset such that it is only decipherable by the approved trusted device of the lessee (or sub-lessee). The access and devices management service also ensures each trusted device provides trustworthy attestation evidence that (a) it is in the approved system configuration (hardware, firmware, software), (b) that it is in possession of the correct cryptographic keys for the asset, and (c) that it can provide attestation evidence to its current system operational state. In concert with a synchronization authentication service, the access and devices management service ensures that the digital asset leasing system can prove that the asset instance policies are enforced. At the end of the period of leasing, the access and devices management service system can remotely delete the keys in the trusted device of the asset holder (lessee or sub-lessee) and erase the protected memory in the trusted device.

Example 5: A method to lease a digital asset from its owner to a lessee for fixed duration of time, using a combination of DLT systems, trusted devices, and a continual synchronization service and liveliness proof. The lessee accesses the asset using a trusted device belonging to the lessee, where the trusted device performs a continuous synchronization and liveliness proof to a synchronization authentication service. The synchronization authentication service performs a continual periodic synchronization with the lessee's trusted devices, ensuring that the correct cryptographic keys are used to access a protected digital asset file within the trusted device and ensuring the continual freshness of the state of the digital asset. The synchronization authentication service, in conjunction with an access and devices management service, enforces an asset instance policy associated with the given asset. If the trusted device fails in its regular synchronization and liveliness, the access and devices management service remotely deletes the keys in the trusted device used by the device to access the digital asset.

Example 6: A method to perform on-going authentication and liveliness of a trusted device that is currently in possession of a digital asset, whereby a synchronization authentication service and a trusted device of a lessee perform continuous periodic exchange of a synchronization order token (from the synchronization authentication service) and a synchronization response token (from the trusted device). The synchronization order token contains a data structure that carries a device challenge value that is generated from a number of parameters. The device challenge is unique only to the intended trusted device and can be responded to only by that trusted device using a synchronization response token that proves the trusted device is alive and functional.

Example 7: A method for users to visually validate authenticity of a random synchronization counter value (SCV) as generated by the synchronization authentication service, whereby the synchronization authentication service transmits the synchronization counter value to a trusted device and publishes the synchronization counter value to a blockchain or DLT that is readable publicly via a mobile app (or other client application). The synchronization counter value is displayed together with the digital asset (e.g., using a digital display device), permitting the user to compare the synchronization counter value being displayed against the synchronization counter value reported by the mobile app, which read it from the blockchain/DLT system.

Example 8: A method to provide proof of asset insurance by insurance provider for the lease of a digital asset from its owner to a lessee. The method utilizes a device verification service (DVS), which interrogates the status owner's trusted device and the lessee's trusted device in a live exchange. Each device must produce a device attestation report to the device verification service, which is controlled by the insurance provider. The device verification service also compares the newly received device attestation report with the device attestation report tokens found on the device status DLT system. The device attestation report tokens were recorded to the device status DLT system independently by the owner's devices and the lessee's device at an earlier time when the lease was agreed between the asset owner and lessee. If the insurance provider is satisfied with the compliance of both devices to the provider's policy for asset leasing, it will then issue a new proof of insurance token (or “PI” token) onto the asset leasing DLT system.

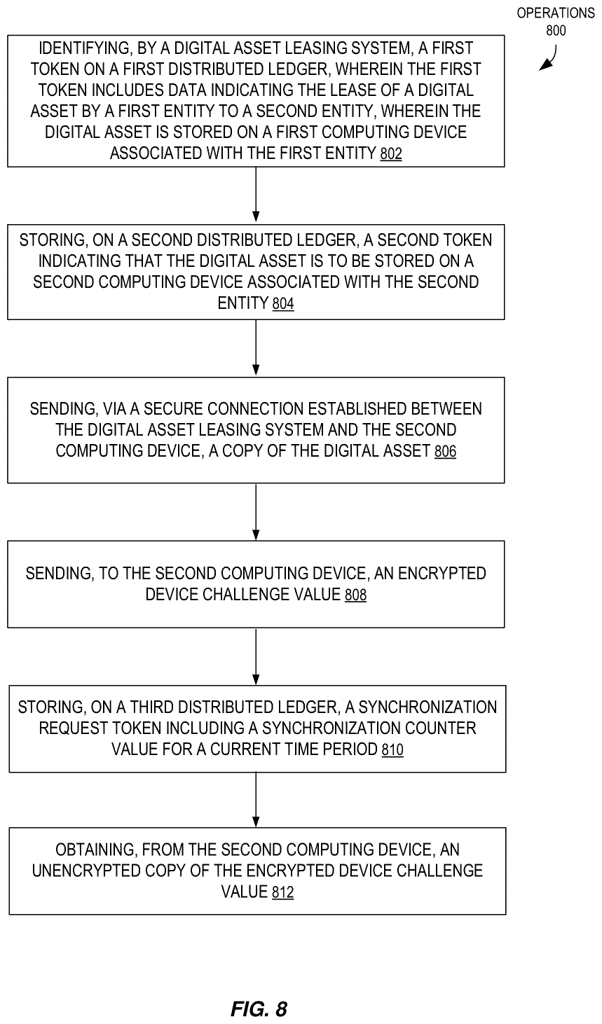

FIG. 8 is a flow diagram illustrating operations 800 of a method for providing a secure digital asset leasing system according to some examples. Some or all of the operations 800 (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 800 are performed by components of the digital asset leasing system 100 or other components of the other figures.

The operations 800 include, at block 802, identifying, by a digital asset leasing system, a first token on a first distributed ledger, the first token including data indicating a lease of a digital asset by a first entity to a second entity, the digital asset stored on a first computing device associated with the first entity.

The operations 800 further include, at block 804, storing, on a second distributed ledger, a second token indicating that the digital asset is to be stored on a second computing device associated with the second entity.

The operations 800 further include, at block 806, sending, via a secure connection established between the digital asset leasing system and the second computing device, a copy of the digital asset;

The operations 800 further include, at block 808, sending, to the second computing device, an encrypted device challenge value;

The operations 800 further include, at block 810, storing, on a third distributed ledger, a synchronization request token including a synchronization counter value for a current time period.

The operations 800 further include, at block 812, obtaining, from the second computing device, an unencrypted copy of the encrypted device challenge value.

### Implementation Mechanism—Hardware Overview

According to one example, the techniques described herein are implemented by one or more special-purpose computing devices. The special-purpose computing devices may be desktop computer systems, portable computer systems, handheld devices, networking devices or any other device that incorporates hard-wired and/or program logic to implement the techniques. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

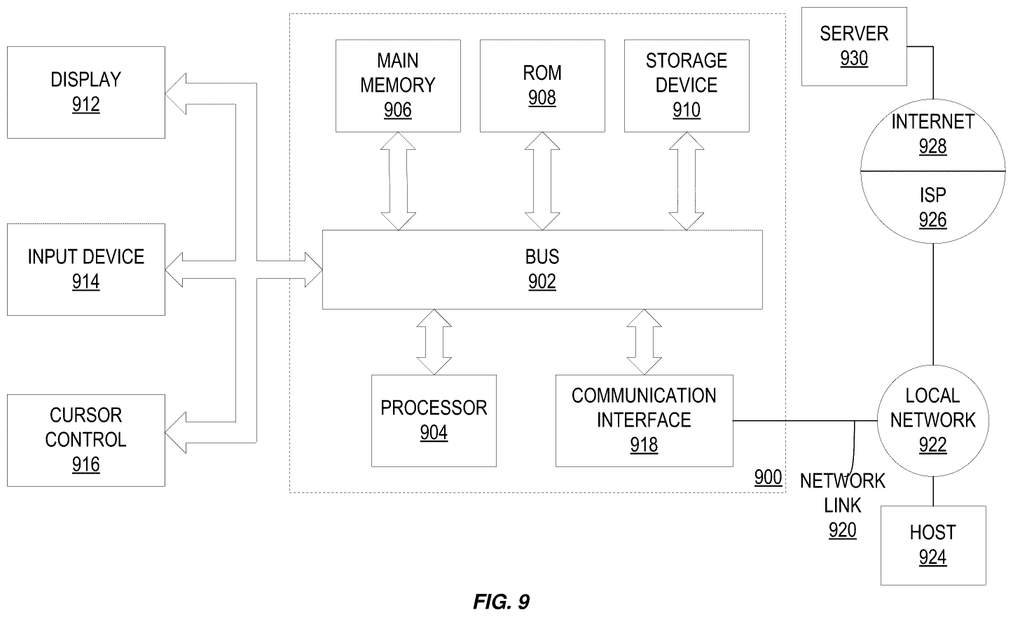

FIG. 9 is a block diagram that illustrates a computer system 900 utilized in implementing the above-described techniques, according to an example. Computer system 900 may be, for example, a desktop computing device, laptop computing device, tablet, smartphone, server appliance, computing mainframe, multimedia device, handheld device, networking apparatus, or any other suitable device.

Computer system 900 includes one or more buses 902 or other communication mechanism for communicating information, and one or more hardware processors 904 coupled with buses 902 for processing information. Hardware processors 904 may be, for example, general purpose microprocessors. Buses 902 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 900 also includes a main memory 906, such as a random-access memory (RAM) or other dynamic or volatile storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 a special-purpose machine that is customized to perform the operations specified in the instructions.

Computer system 900 further includes one or more read only memories (ROM) 908 or other static storage devices coupled to bus 902 for storing static information and instructions for processor 904. One or more storage devices 910, such as a solid-state drive (SSD), magnetic disk, optical disk, or other suitable non-volatile storage device, is provided and coupled to bus 902 for storing information and instructions.

Computer system 900 may be coupled via bus 902 to one or more displays 912 for presenting information to a computer user. For instance, computer system 900 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 912 may include, without limitation, plasma display devices, projectors, cathode ray tube (CRT) monitors, electronic paper, virtual reality headsets, braille terminal, and/or any other suitable device for outputting information to a computer user. In an example, any suitable type of output device, such as, for instance, an audio speaker or printer, may be utilized instead of a display 912.

One or more input devices 914 are coupled to bus 902 for communicating information and command selections to processor 904. One example of an input device 914 is a keyboard, including alphanumeric and other keys. Another type of user input device 914 is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane. Yet other examples of suitable input devices 914 include a touch-screen panel affixed to a display 912, cameras, microphones, accelerometers, motion detectors, and/or other sensors. In an example, a network-based input device 914 may be utilized. In such an example, user input and/or other information or commands may be relayed via routers and/or switches on a Local Area Network (LAN) or other suitable shared network, or via a peer-to-peer network, from the input device 914 to a network link 920 on the computer system 900.

A computer system 900 may implement techniques described herein using customized hard-wired logic, one or more ASICs or FPGAs, firmware and/or program logic which in combination with the computer system causes or programs computer system 900 to be a special-purpose machine. According to one example, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative examples, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or a solid-state drive of a remote computer. The remote computer can load the instructions into its dynamic memory and use a modem to send the instructions over a network, such as a cable network or cellular network, as modulate signals. A modem local to computer system 900 can receive the data on the network and demodulate the signal to decode the transmitted instructions. Appropriate circuitry can then place the data on bus 902. Bus 902 carries the data to main memory 906, from which processor 904 retrieves and executes the instructions. The instructions received by main memory 906 may optionally be stored on storage device 910 either before or after execution by processor 904.

A computer system 900 may also include, in an example, one or more communication interfaces 918 coupled to bus 902. A communication interface 918 provides a data communication coupling, typically two-way, to a network link 920 that is connected to a local network 922. For example, a communication interface 918 may be an integrated services digital network (ISDN) card, cable modem, satellite modem, or a modem to provide a data communication connection to a corresponding type of telephone line. As another example, the one or more communication interfaces 918 may include a local area network (LAN) card to provide a data communication connection to a compatible LAN. As yet another example, the one or more communication interfaces 918 may include a wireless network interface controller, such as an 802.11-based controller, Bluetooth controller, Long Term Evolution (LTE) modem, and/or other types of wireless interfaces. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by a Service Provider 926. Service Provider 926, which may for example be an Internet Service Provider (ISP), in turn provides data communication services through a wide area network, such as the worldwide packet data communication network now commonly referred to as the “Internet” 928. Local network 922 and Internet 928 both use electrical, electromagnetic, or optical signals that carry digital data streams. The signals through the various networks and the signals on network link 920 and through communication interface 918, which carry the digital data to and from computer system 900, are example forms of transmission media.

In an example, computer system 900 can send messages and receive data, including program code and/or other types of instructions, through the network(s), network link 920, and communication interface 918. In the Internet example, a server 930 might transmit a requested code for an application program through Internet 928, ISP 926, local network 922 and communication interface 918. The received code may be executed by processor 904 as it is received, and/or stored in storage device 910, or other non-volatile storage for later execution. As another example, information received via a network link 920 may be interpreted and/or processed by a software component of the computer system 900, such as a web browser, application, or server, which in turn issues instructions based thereon to a processor 904, possibly via an operating system and/or other intermediate layers of software components.

In an example, some or all of the systems described herein may be or comprise server computer systems, including one or more computer systems 900 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an example, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an example, the cloud-based components may be implemented by third-party entities, on behalf of another entity for whom the components are deployed. In other examples, however, the described systems may be implemented entirely by computer systems owned and operated by a single entity.

In an example, an apparatus comprises a processor and is configured to perform any of the foregoing methods. In an example, a non-transitory computer readable storage medium, storing software instructions, which when executed by one or more processors cause performance of any of the foregoing methods.

### Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, examples of the invention have been described with reference to numerous specific details that may vary from implementation to implementation. Thus, the sole and exclusive indicator of what is the invention and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate examples are discussed herein, any combination of examples and/or partial examples discussed herein may be combined to form further examples.

Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
identifying, by a digital asset leasing system, a first token on a first distributed ledger, the first token including data indicating a lease of a digital asset by a first entity to a second entity, the digital asset stored on a first computing device associated with the first entity;
storing, on a second distributed ledger, a second token indicating that the digital asset is to be stored on a second computing device associated with the second entity;
sending, via a secure connection established between the digital asset leasing system and the second computing device, a copy of the digital asset;
sending, to the second computing device, an encrypted device challenge value;
storing, on a third distributed ledger, a synchronization request token including a synchronization counter value for a current time period; and
obtaining, from the second computing device, an unencrypted copy of the encrypted device challenge value.

2. The computer implemented method of claim 1, further comprising preventing, by the digital asset leasing system, the first entity from consuming the digital asset on the first computing device during a time duration of the lease.

3. The computer implemented method of claim 1, further comprising:
obtaining, from the second computing device, a device attestations report identifying characteristics of hardware and software components of the second computing device; and
determining, based on the device attestations report, that the second computing device is a trusted computing device.

4. The computer-implemented method of claim 1, further comprising storing the unencrypted copy of the encrypted device challenge value in a synchronization response token signed by the second computing device onto the first distributed ledger.

5. The computer implemented method of claim 1, the first token including further data indicating a time duration of the lease.

6. The computer implemented method of claim 1, the first token including further data indicating conditions upon which the first entity can cancel the lease before the expiration of a time duration of the lease.

7. The computer-implemented method of claim 1, further comprising sending a request to the first computing device to delete the digital asset from storage of the first computing device.

8. Non-transitory computer-readable media having stored thereon instructions that, when executed by one or more processors, cause the one or more processors to perform operations including:
identifying, by a digital asset leasing system, a first token on a first distributed ledger, the first token including data indicating a lease of a digital asset by a first entity to a second entity, the digital asset stored on a first computing device associated with the first entity;
storing, on a second distributed ledger, a second token indicating that the digital asset is to be stored on a second computing device associated with the second entity;
sending, via a secure connection established between the digital asset leasing system and the second computing device, a copy of the digital asset;
sending, to the second computing device, an encrypted device challenge value;
storing, on a third distributed ledger, a synchronization request token including a synchronization counter value for a current time period; and
obtaining, from the second computing device, an unencrypted copy of the encrypted device challenge value.

9. The non-transitory computer-readable media of claim 8, the instructions comprising further instructions that, when executed by one or more processors, further cause the one or more processors to perform operations including preventing, by the digital asset leasing system, the first entity from consuming the digital asset on the first computing device during a time duration of the lease.

10. The non-transitory computer-readable media of claim 8, the instructions comprising further instructions that, when executed by one or more processors, further cause the one or more processors to perform operations including:
obtaining, from the second computing device, a device attestations report identifying characteristics of hardware and software components of the second computing device; and
determining, based on the device attestations report, that the second computing device is a trusted computing device.

11. The non-transitory computer-readable media of claim 8, the instructions comprising further instructions that, when executed by one or more processors, further cause the one or more processors to perform operations including storing the unencrypted copy of the encrypted device challenge value in a synchronization response token signed by the second computing device onto the first distributed ledger.

12. The non-transitory computer-readable media of claim 8, the first token including further data indicating a time duration of the lease.

13. The non-transitory computer-readable media of claim 8, the first token including further data indicating conditions upon which the first entity can cancel the lease before the expiration of a time duration of the lease.

14. The non-transitory computer-readable media of claim 8, the instructions comprising further instructions that, when executed by one or more processors, further cause the one or more processors to perform operations including sending a request to the first computing device to delete the digital asset from storage of the first computing device.

15. A computing device comprising:
one or more processors; and
non-transitory computer-readable media having stored thereon instructions that, when executed by the one or more processors, cause the one or more processors to perform operations including:
identifying, by a digital asset leasing system, a first token on a first distributed ledger, the first token including data indicating a lease of a digital asset by a first entity to a second entity, the digital asset stored on a first computing device associated with the first entity;
storing, on a second distributed ledger, a second token indicating that the digital asset is to be stored on a second computing device associated with the second entity;
sending, via a secure connection established between the digital asset leasing system and the second computing device, a copy of the digital asset;
sending, to the second computing device, an encrypted device challenge value;
storing, on a third distributed ledger, a synchronization request token including a synchronization counter value for a current time period; and
obtaining, from the second computing device, an unencrypted copy of the encrypted device challenge value.

16. The computing device of claim 15, the instructions comprising further instructions that, when executed by one or more processors, further cause the one or more processors to perform operations including preventing, by the digital asset leasing system, the first entity from consuming the digital asset on the first computing device during a time duration of the lease.

17. The computing device of claim 15, the instructions comprising further instructions that, when executed by one or more processors, further cause the one or more processors to perform operations including:
obtaining, from the second computing device, a device attestations report identifying characteristics of hardware and software components of the second computing device; and
determining, based on the device attestations report, that the second computing device is a trusted computing device.

18. The computing device of claim 15, the instructions comprising further instructions that, when executed by one or more processors, further cause the one or more processors to perform operations including storing the unencrypted copy of the encrypted device challenge value in a synchronization response token signed by the second computing device onto the first distributed ledger.

19. The computing device of claim 15, the first token including further data indicating a time duration of the lease.

20. The computing device of claim 15, the first token including further data indicating conditions upon which the first entity can cancel the lease before the expiration of a time duration of the lease.
